(19) United States
(12) Patent Application Publication
(10) Pub. No.: US 2005/0231851 A1
(43) Pub. Date: Oct. 20, 2005

(54) Manufacturing method of magnetic head slider, magnetic head slider and magnetic device

(75) Inventors: Kazuhiro Yoshida, Tokyo (JP); Jun Ito, Tokyo (JP); Kan Takahashi, Tokyo (JP); Mitsunobu Hanyu, Tokyo (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/085,051

(22) Filed: Mar. 22, 2005

(30) Foreign Application Priority Data
Mar. 30, 2004 (JP) JP 2004-098526

(51) Int. Cl. G11B 5/60

(52) U.S. Cl. 360/235.2; 29/603.01; 29/603.16; 29/603.15

(57) ABSTRACT

A manufacturing method of a magnetic head slider 5 is to perform milling processes for at least three times to a slider main body 50 to form a flying surface, and thereby, the milling process is performed at variety of depths more than the number of milling processes. These three times milling process composed of: for example, a first milling processes forming a first mask on the slider main body 50 and performing a milling at a first depth; a second milling process changing the first mask to a second mask and performing the milling at a second depth, after the first milling process; and a third milling process changing the second mask to a third mask and performing the milling at a third depth, after the second milling process. Namely, a cycle of the masking, the milling, and a removal of the mask is performed three cycles, and thereby, milling surfaces with at least four varieties of heights or more can be formed easily.

### CROSS REFERENCE TO RELATED APPLICATIONS

This application is based upon and claims the benefit of priority from the prior Japanese Patent Application No. 2004-098526, filed on Mar. 30, 2004; the entire contents of which are incorporated herein by reference.

### BACKGROUND

1. Field of the Invention

The present invention relates to a manufacturing method of a magnetic head slider including a head element performing a read/write from/to a magnetic disk, and to the magnetic head slider and a magnetic disk device.

2. Description of the Related Art

Recently, in a magnetic disk device, it is steadily required to have a mass storage capacity. To satisfy this requirement, it is effective means to improve a recording density of a magnetic disk, and to reduce a flying amount of a magnetic head slider flying above a surface of a driving magnetic disk.

This flying amount is determined by a balance of a flying force generated at the magnetic head slider by an air viscous flow flowing between the magnetic disk and the magnetic head slider, and a spring load added to the magnetic head slider from load beam. Namely, the flying force of the magnetic head slider is controlled by the above-stated air viscous flow, and therefore, it is required to process a flying surface of the magnetic head slider (facing surface with the magnetic disk) into an appropriate shape.

Consequently, a manufacturing method of the magnetic head slider in which a step at an outflow side of the air viscous flow on the flying surface of the magnetic head slider can be formed with a high degree of accuracy is suggested (for example, refer to Japanese Patent Laid-open Application No. 2003-323707).

By the way, in recent years, a large number of magnetic disk devices are mounted on mobile devices, and so on, and they are used under various circumstances under more various circumstances than before. In considering this situation, it can be said that the most important item is to improve a pressure reducing characteristic being a reliability evaluation performance at a low pressure environment such as a highland. A lowering of the flying amount of a slider under the low pressure environment is caused by a decrease of a generated flying force in accordance with a decrease of an air density under the low pressure environment. Under the low pressure environment, the air density becomes lower, and therefore, because the pressure flying the slider becomes small, the flying amount becomes small with the same flying attitude and space with those of at the time of an atmospheric pressure.

Consequently, the flying attitude and the flying space of the slider are lowered until the same flying force at the time of the atmospheric pressure can be obtained, so as to take a balance of a load and the flying force. Therefore, the requirements to realize a process forming of the flying surface into an appropriate shape at low cost, and to improve the above-described pressure reducing characteristic become high for the magnetic head slider.

### SUMMARY

The present invention is made to solve the above-stated problems, and the object thereof is to provide a manufacturing method of a magnetic head slider, a magnetic head slider and a magnetic disk device, in which an improvement of the pressure reducing characteristic can be realized at low cost.

To achieve the above-stated object, the manufacturing method of the magnetic head slider according to one aspect of the present invention including: milling processes for at least three times performed on a slider to form a flying surface, providing variety of depths more than the number of milling processes to be milling processed. Here, for example, these milling processes for three times includes: a first milling process forming a first mask on the slider to form the flying surface and performing a milling at a first depth; a second milling process changing the first mask to a second mask, performing the milling at a second depth, after the first milling process; and a third milling process changing the second mask to a third mask, performing the milling at a third depth, after the second process.

### BRIEF DESCRIPTION OF THE DRAWINGS

FIG. 1 is a perspective view showing a magnetic disk device mounting a magnetic head slider according to an embodiment of the present invention.

FIG. 2 is a plan view showing a head gimbal assembly included in the magnetic disk device in FIG. 1.

FIG. 3 is a perspective view showing a magnetic head slider supported at a tip portion of the head gimbal assembly shown in FIG. 2.

FIG. 4 is a perspective view showing the magnetic head slider shown in FIG. 3 seen from a flying surface (ABS: Air Bearing Surface) side.

FIG. 5 is a plan view of the magnetic head slider shown in FIG. 4.

FIG. 6 is a view to explain a first milling process given to a flying surface of a slider main body of the magnetic head slider shown in FIG. 5.

FIG. 7 is a view to explain a second milling process given to the flying surface of the slider main body in FIG. 6.

FIG. 8 is a view to explain a third milling process performed to the flying surface of the slider main body in FIG. 7.

FIG. 9 is a view showing a relation between milling depths, masking regions, and milling regions in the first to third milling processes.

FIG. 10 is a view to explain a pressure reducing characteristic of the magnetic head slider shown in FIG. 4.

FIG. 11A and FIG. 11B are views to explain points when masks are formed on the slider main body.

FIG. 12A and FIG. 12B are views showing a characteristic of a generated force of a side pad composed of two steps.

FIG. 13A and FIG. 13B are views showing the characteristic of the generated force of the side pad composed of three steps.

FIG. 14A and FIG. 14B are views showing the characteristic of the generated force of the side pad composed of four steps.

### DETAILED DESCRIPTION

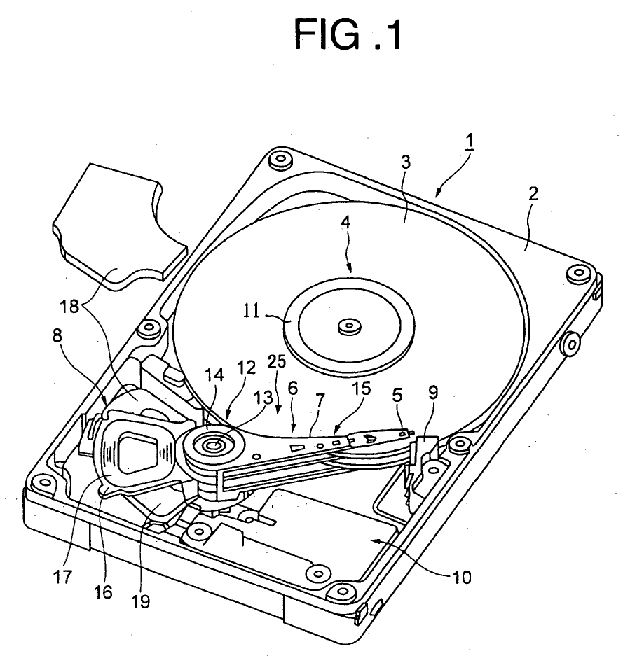

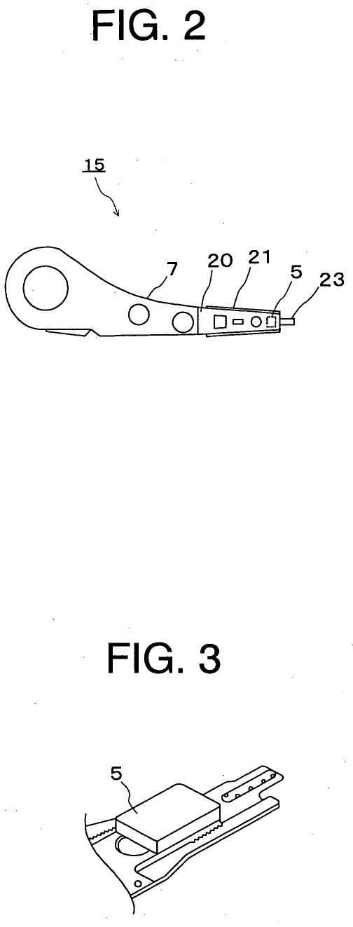

Hereinafter, a best mode to implement the present invention is described based on the drawings. FIG. 1 is a perspective view showing a magnetic disk device mounting a magnetic head slider according to one embodiment of the present invention, FIG. 2 is a plan view showing a head gimbal assembly included in the magnetic disk device, and FIG. 3 is a perspective view showing a magnetic head slider supported at a tip portion of the head gimbal assembly. As shown in FIG. 1, a magnetic disk device 1 according to this embodiment includes a case 2 in a rectangle box shape having an opening upper surface, and a top cover (not shown), for example, screwed to this case 2 so as to cover the upper surface of the case 2.

Within the case 2, for example, two pieces of disks (platter) 3 being recording media in a disk shape, a spindle motor 4 as a disk driving mechanism to support and rotate these disks 3, and a head actuator 25 are disposed. Here, as the disk 3, for example, a platter having a diameter of 65 mm (2.5 inches) and providing magnetic recording layers on both surfaces are adopted. These disks 3 are engaged at an outer periphery of a hub (not shown) of the spindle motor 4 and fixed by a clamp spring 11. Namely, the two pieces of disks 3 integrally rotate by driving the spindle motor 4.

The head actuator 25 includes a carriage 6 constituted by multiply layered head arm assemblies 15, a bearing unit 12 pivotably supporting the carriage 6, and a voice coil motor 8 driving the carriage 6. The head gimbal assembly 15 is constituted by a suspension 20 including a later-described magnetic head slider 5 mounting a head (magnetic pole element) performing a read/write of signals from/to the disk 3 and a tab 23 at a tip portion thereof, and an arm 7 supporting this suspension 20 at a tip portion.

In the above-stated bearing unit 12 supporting the carriage 6, a bearing shaft 13 provided perpendicular to a bottom wall of the case 2, and a hub 14 in cylindrical shape pivotably supported by the bearing shaft 13 via a pair of bearings, are provided. The voice coil motor 8 includes a voice coil 17 fixed in a supporting frame 16 at a base end portion of the head actuator 25, a pair of yokes 18 fixed on the case 2 so as to sandwich the voice coil 17, and a magnet 19 fixed to one of the yokes 18.

Further, within the case 2, a ramp 9 holding a head at a predetermined retreat position departed from the disk 3 sliding with the tab 23, when the magnetic head slider 5 is moved to an outer peripheral portion of the disk 3, and a substrate unit 10 mounting a head driver IC, and so on, are accommodated. Besides, at a reverse side of a parts accommodating portion of the case 2, a print circuit substrate (not shown) mounting a CPU for performing controls of the spindle motor 4, the voice coil motor 8, and the head via the substrate unit 10, a memory, an HDD controller, and the other circuits, are attached by screw cramps, and so on.

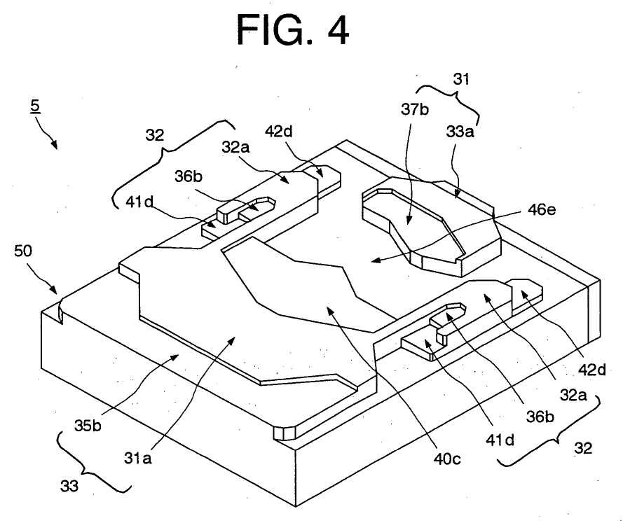

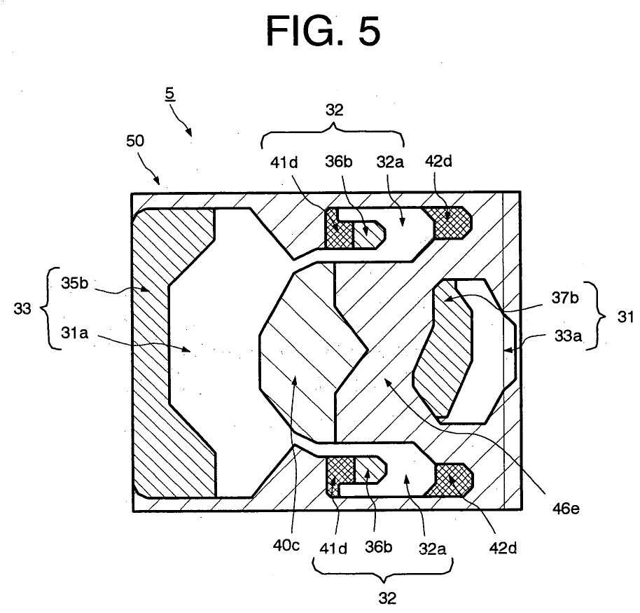

Next, a structure of the magnetic head slider 5 according to the present embodiment is described. Here, FIG. 4 is a perspective view showing the magnetic head slider 5 of the present embodiment seen from a flying surface side, and FIG. 5 is a plan view thereof. As shown in these drawings, on the flying surface (ABS: Air Bearing Surface) of the magnetic head slider 5, four positive pressure generation portions of a trailing pad 31, two side pads 32, and a leading pad 33 are provided. These positive pressure generation portions are respectively constituted by plural regions having different positions of surface depths, to improve generation efficiency of positive pressure.

Namely, the trailing pad 31 is constituted by, for example, a first step trailing pad region 33a composed of a surface never subjected to a milling (non-milling surface), and so on within a slider manufacturing process, and a second step trailing pad region 37b disposed at an inflow end side of the first step trailing pad region 33a and the height of the surface being lower than that of the first step trailing pad region 33a.

The side pads 32 are constituted by first step side pad regions 32a composed of the non-milling surfaces, and so on, second step side pad regions 36b disposed at inflow end sides of the first step side pad regions 32a and the height of the surfaces being lower than that of the first step side pad regions 32a, and third step side pad regions 41d disposed more inflow end sides than the second step side pad regions 36b and the height of the surfaces being lower than that of the second step side pad regions 36b. Further, at the trailing pad 31 side of the side pads 32 (outflow end side of the side pad), skirt portions 42d formed at the same height with the third step side pad regions 41d are provided. This skirt portion 42d can increase a negative pressure and enhance the pressure reducing characteristic and an shock impact resistance.

The leading pad 33 is constituted by a first step leading pad region 31a composed of the non-milling surface, and so on, and a second step leading pad region 35b disposed at an inflow end side of the first step leading pad region 31a and the height of the surface being lower than that of the first step leading pad region 31a.

Besides, a region surrounded by the trailing pad 31, the two side pads 32, and the leading pad 33 is a region further lower than the height of the surface of the above-stated respective pad regions, and it is a negative pressure generation portion 46e called a negative pressure cavity. Further, at the leading pad 33 side of the negative pressure generation portion 46e, a negative pressure dead zone region 40c formed as a region shallower than the negative pressure generation portion 46e to inhibit generation of negative pressure, is disposed. The negative pressure dead zone region 40c is provided at the inflow end side of the negative pressure cavity, then the generation center of the negative pressure can be moved toward the trailing side, and thereby, the pressure reducing characteristic can be enhanced.

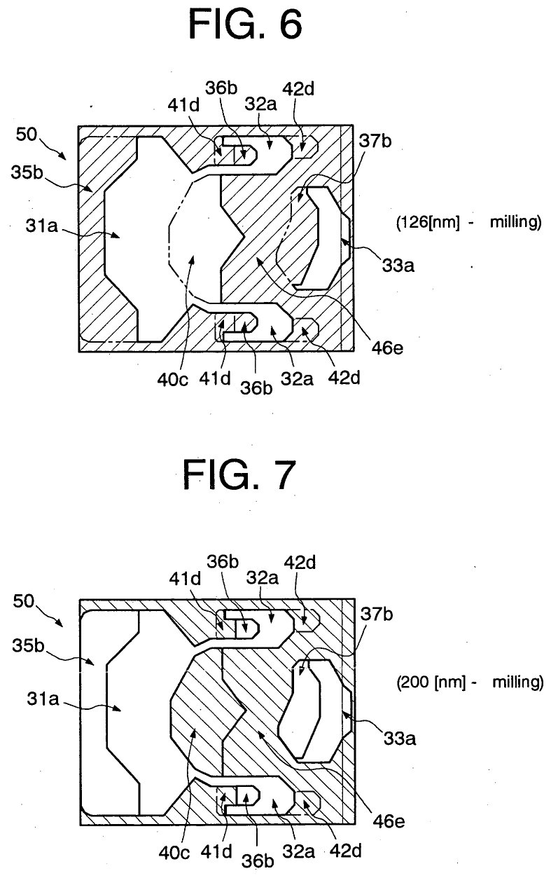

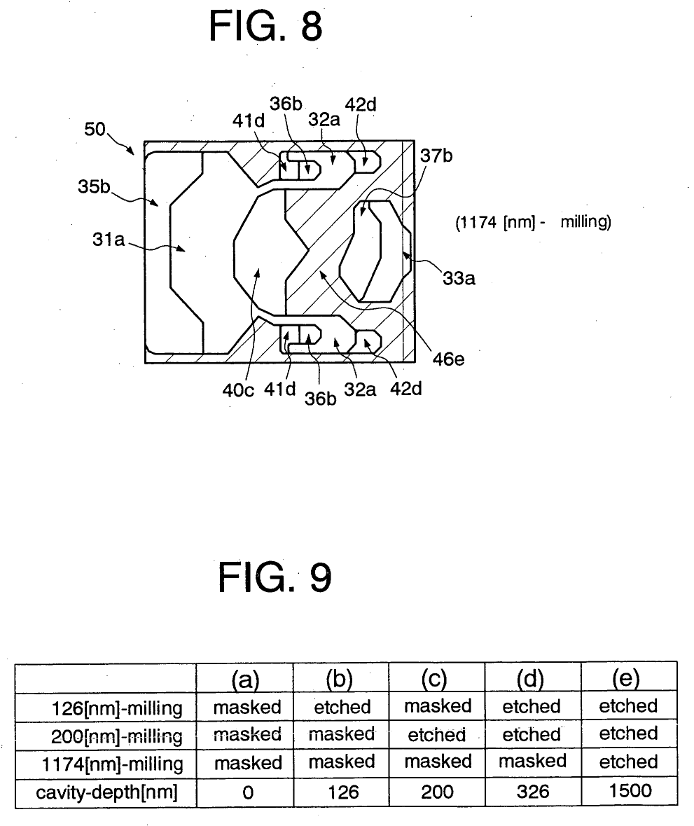

Next, a manufacturing method of the magnetic head slider 5 structured as stated above is described mainly based on FIG. 6 to FIG. 9. Here, FIG. 6 is a view to explain a first milling process performed on the flying surface of a slider main body, FIG. 7 is a view to explain a second milling process, FIG. 8 is a view to explain a third milling process, and FIG. 9 is a view showing a relation between milling depths, masking regions, and milling regions in the first to third respective milling processes.

In the manufacturing method of the magnetic head slider of the present embodiment, a cycle of a masking, a milling, and a removal of a mask is performed for three cycles, and thereby, the magnetic head slider 5 having milling surfaces (surfaces which are milling processed) with heights of at least four varieties or more on the flying surfaces, can be formed. Namely, in the first milling process, as shown in FIG. 6 and FIG. 9, first masks are formed in the above stated regions 33a, 32a, 31a, and 40c (non-hatching portions in FIG. 6) on the surface of the slider main body 50 to form the flying surface. Further, in the regions 35b, 41d, 36b, 42d, 46e, and 37b (hatching portions in FIG. 6) exposing (opening) from the portions covered with the first masks of the slider main body 50, the milling is performed at a first depth, for example, of 126 nm.

Next, in the second milling process, as shown in FIG. 7 and FIG. 9, after a removal of the first masks, second masks are formed in the regions 35b, 31a, 32a, 37b, 33a, and 36b (non-hatching portions in FIG. 7) of the slider main body 50. Further, in the regions 40c, 41d, 42d, and 46e, (hatching portions in FIG. 7) exposing from the portions covered with the second masks of the slider main body 50, the milling is performed at a second depth deeper than the first depth, for example, of 200 nm.

Subsequently, in the third milling process, as shown in FIG. 8 and FIG. 9, after the removal of the second masks, third masks are formed in the regions 35b, 31a, 40c, 41d, 36b, 32a, 42d, 37b, and 33a (non-hatching portions in FIG. 8) of the slider main body 50. Further, in the region 46e (hatching portion in FIG. 8) exposing from the portions covered with the third masks of the slider main body 50, the milling is performed at a depth deeper than the first and second depths, for example, of 1174 nm.

Namely, with a masking pattern (a) in FIG. 9, the non-milling surface (depth: 0 nm) is formed. Besides, with a masking pattern (b) in FIG. 9, the milling surface at 126 nm depth is formed, and with a masking pattern (c) in FIG. 9, the milling surface at 200 nm depth is formed. Further, with a masking pattern (d) in FIG. 9, the milling surface at 326 (126+200) nm depth is formed, and further, with a masking pattern (e) in FIG. 9, the milling surface (cavity surface) at 1500 (126+200+1174) nm depth is formed.

Herewith, the cycle of the masking, the milling, and the removal of the mask, is performed for three cycles, and thereby, the milling surfaces with heights of at least four varieties or more are formed.

Further, by applying a masking pattern other than the masking patterns (a) to (e) in FIG. 9, the milling surfaces (cavity surface) at the depths of 1174 nm, 1300 (126+1174) nm, and 1374 (200+1174) nm are formed. Namely, by performing the milling processes for three times, the surfaces with the heights of eight (third power of two) ways can be formed. Here, when a ratio of the milling depth of, for example, 1:2:4, and so on, (Nth power of two) is selected as the milling process, it is possible to form the plural milling surfaces having depths different evenly, at the ratio of the depths of the depth 1, the depth 2, the depth 4 formed by the first milling, the depth 3 (1+2), the depth 5 (1+4), the depth 6 (2+4) formed by the second milling, and the depth 7 (1+2+4) formed by the third milling, respectively. Besides, when the depth of the shallowest milling surface milling-processed from the surface of the slider main body 50, from the non-milling surface, is set as one, and when N is a natural number, it is desirable to set the milling depths of the respective milling processes within the range from 0.9×2^{N} to 1.1×2^{N}. Speaking in detail, in the milling process, a tolerance of 10% is required, and when the number of milling processes is N, in which the milling is performed at the depths of the first, second, third to Nth, and the shallowest cavity depth is set as one, it is possible to select the milling depth at the ratio of the above-stated 0.9×2^{N} to 1.1×2^{N} (N=1, 2, and so on: number of milling processes), such as 1:1.8 to 2.2:3.6 to 4.4, and so on.

Here, the milling process of the two cycles and the milling process of the three cycles are compared shortly. When what is called the negative pressure cavity is formed on the surface of the slider, the milling surface at the depth of at least 1 μm to 2 μm is required. Besides, the case when the milling surface at the depth of 80 nm to 200 nm is formed on a step surface is considered. As an example, to form a slider having cavity depths of, for example, 1500 nm and 150 nm, the milling to dig out 150 nm and the milling to dig out 1350 nm are required. The milling surface of 150 nm is formed by the first milling process, and for example, the cavity at the depth of 1500 (150+1350) nm is formed by the second milling process. At this time, the selective cavity depths are, as a whole, the non-milling surface (0 (zero) nm), 150 nm, 1350 nm, and 1500 nm, and the height can be selected only from among the four varieties. The difference of the cavity depths between 1350 nm and 1500 nm can provide a little improvement in the characteristic to the slider.

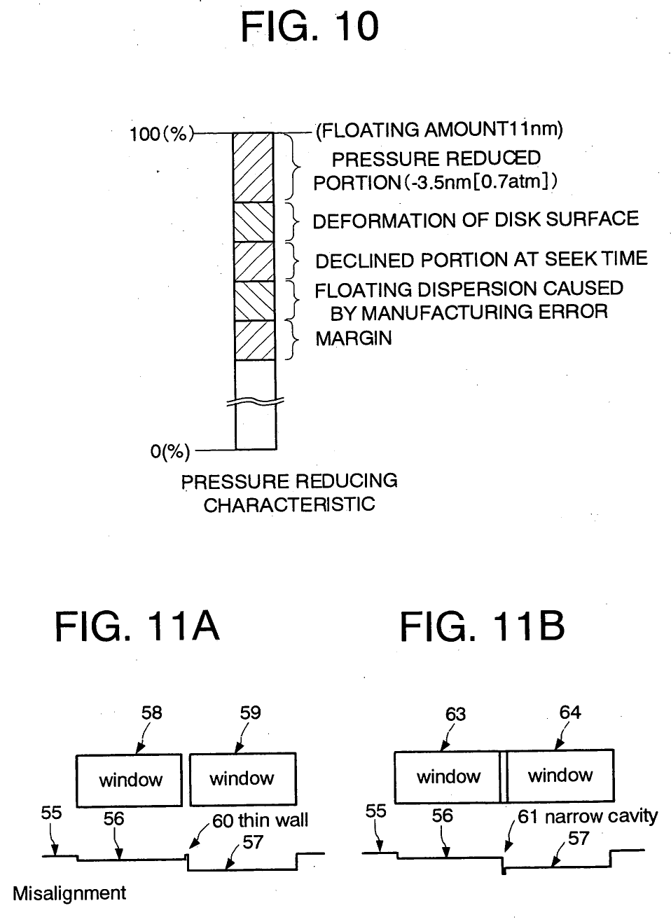

Here, the pressure reducing characteristic of the magnetic head slider is described. As shown in FIG. 10, the pressure reducing characteristic can be said that it is the characteristic to absorb disturbance elements such as an amount of head flying decline at the time of pressure reduction, a deformation of a disk, a declined flying amount at a seek time, a dispersion caused by a manufacturing error, and a margin, reflecting a theoretical head flying amount (for example, 11 nm), and so on. When the magnetic head slider is manufactured by the milling processes of three cycles as the present embodiment, a lot of alternatives as described below are provided as the cavity depths. Namely, a recess of 1 μm to 2 μm is required to form the negative pressure cavity, as is the same as the case described above. Besides, the case when the milling surface at the depth of 200 nm to 400 nm is formed on the step surface is considered. For example, when the three varieties of milling processes of 150 nm, 1000 nm, and 350 nm are prepared, the desired height can be selected from among the following eight varieties, 0 (zero) nm, 150 nm, 350 nm, 500 nm, 1000 nm, 1150 nm, 1350 nm, and 1500 nm. Herewith, a flexibility of a height setting of the flying surface to be formed on the slider is improved, and a flying characteristic of the slider including the pressure reducing characteristic, and so on, can be improved.

Next, points when the masks are formed on the surface of the slider main body 50 is described based on FIG. 11A and FIG. 11B. As shown in these drawings, when a mask deviance is occurred, it is required not to form a thin wall 60 or a narrow cavity 61 on the flying surface of the slider as much as possible. Here, as shown in FIG. 11A, at the time of forming milling surfaces 56, 57 adjacent with each other by performing the millings of the non-milling surface 55 with two processes, when an opening portion 58 of one mask and an opening portion 59 of the other mask are misaligned, and a gap is made, this gap portion is not milling processed, and remains to be the thin wall 60. If the thin wall 60 is formed, the airflow to flow over the step surface is dammed, and thereby, it has a bad effect on a flying performance. Further, especially, when a vertex of the thin wall 60 becomes the non-milling surface, it can be a cause to scratch a disk because the non-milling surface is near the magnetic disk side.

Meanwhile, as shown in FIG. 11B, at the time of forming the milling surfaces 56, 57 adjacent with each other by performing the millings of the non-milling surface 55 with two processes, when an opening portion 63 of one mask and an opening portion 64 of the other mask are misaligned, and they are overlapped with each other, the overlapped portion is milling processed deeply (the millings on both sides are performed although one side milling is enough normally), and thereby, the narrow cavity 61 is formed. In the narrow cavity, dusts tend to be accumulated because it is hidden behind in the milling process and a mask removing process. Besides, it causes a deterioration of reliability of the device by the dust easily be accumulated even after it is attached to the magnetic disk device main body.

Consequently, the following rules are provided to the patterns of the masks. Namely, it is described with reference to FIG. 11A that when the milling surfaces having different milling depths processed from the surface of the slider are disposed adjacent to each other, the region to be the deeper milling surface 57 of the milling surfaces is to be milled by the milling-process performed for the shallower milling surface 56 of the milling surfaces. Herewith, it is prevented that the thin wall 60 is remained.

Besides, when the above-stated rule is not satisfied, as shown in FIG. 11B, the masks are formed so that the opening portions 64, 63 of the masks respectively formed on the respective regions of the deeper milling surface 57 and the shallower milling surface 56 are dare to be overlapped. Herewith, it is at least prevented to form the thin wall 60 at a sacrifice of forming the narrow cavity 61.

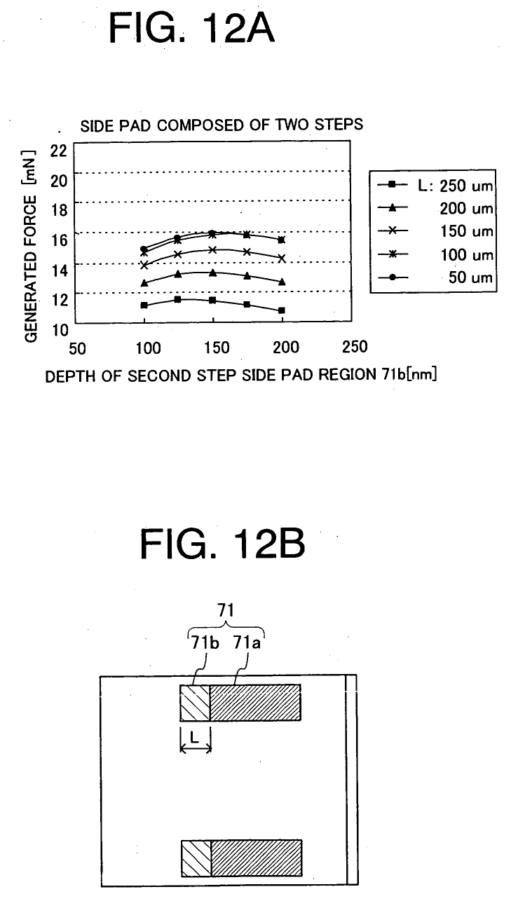

Next, a characteristic of the multi-stepped side pad 32 as stated above is described. FIG. 12 to FIG. 14 are showing results of calculations of generated forces of the various side pads with varying the depths of the side pad regions on and after the second steps and the positions of the steps.

The side pad used for the calculation is the one that an inflow end thereof is 265 um from a leading edge and the size is 120 um×400 um in a slider of a Femto size having the negative pressure cavity at the depth of 1.5 um (1.5 μm or 1.5×10⁻⁶ m, and the same in the following) from the non-milling surface. Incidentally, a peripheral speed and a skew angle are 8.8 m/s and 0 (zero) deg being a condition of a mid-peripheral portion of a 4200 rpm, 2.5 inch HDD, and the flying attitude is that a pitch angle is 150 urad (150 μrad), a flying amount is 10 nm, being the condition of a mid-peripheral portion of the 4200 rpm, 2.5 inch HDD, similarly. The case when the side pad is completely composed of the non-milling surface is calculated to find the positive pressure of 7.23 mN.

FIG. 12A and FIG. 12B show a result of calculation of the generated force of the side pad 71 composed of two steps with varying the depth and the position of the step of the second step side pad region 71b. The position of a boundary line between the first step side pad region 71a being the non-milling surface and the second step side pad region 72b, is varied from 50 um to 250 um in a distance L from the inflow end of the side pad 71, and the depth from the surface of the first step side pad region 72a being the non-milling surface of the second step side pad region 72b is varied from 10 nm to 200 nm. As a result, it becomes the maximum positive pressure of 15.9 mN when the length (L) is 50 um and the depth is 150 nm of the second step side pad region 72b.

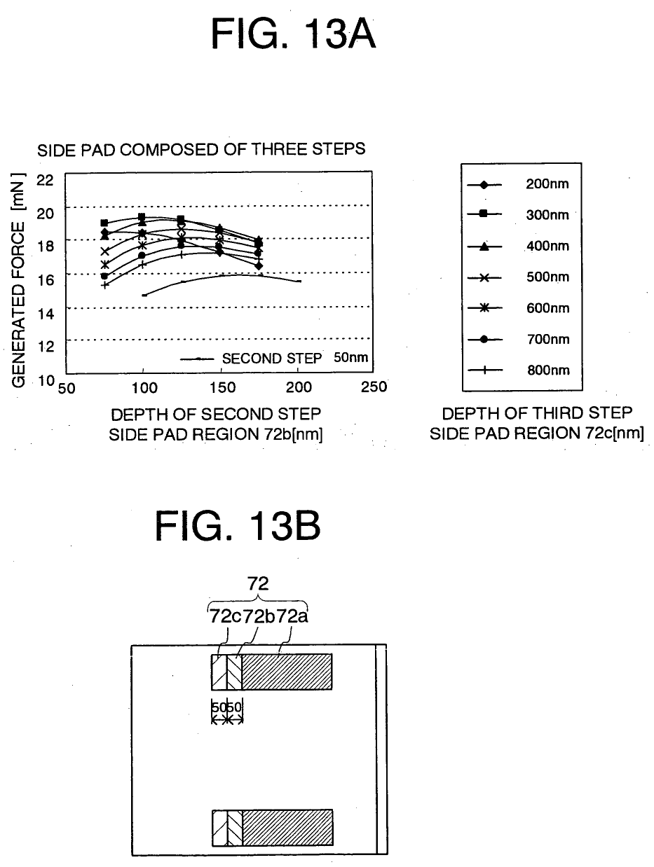

FIG. 13A and FIG. 13B show a result of calculation of the generated force of the side pad 72 composed of three steps with varying the respective depths of the second step side pad region 72b and the third step side pad region 72c from the non-milling surfaces (surface of the first step side pad region 72a). However, the third step side pad region 72c is fixed as the region from the inflow end of the side pad 72 to 50 um, and the range of the second step side pad region 72b is set to be from 50 um to 100 um of the inflow end of the side pad 72.

As a result, the generated force largely exceeds the generation pressure of the side pad 71 composed of two steps, to become the range approximately from 16 mN to 19.3 mN, and the maximum generated force is 19.3 mN when the depth of the second step side pad region 72b from the non-milling surface is 100 nm, and the depth of the third step side pad region 72c from the non-milling surface is 300 nm.

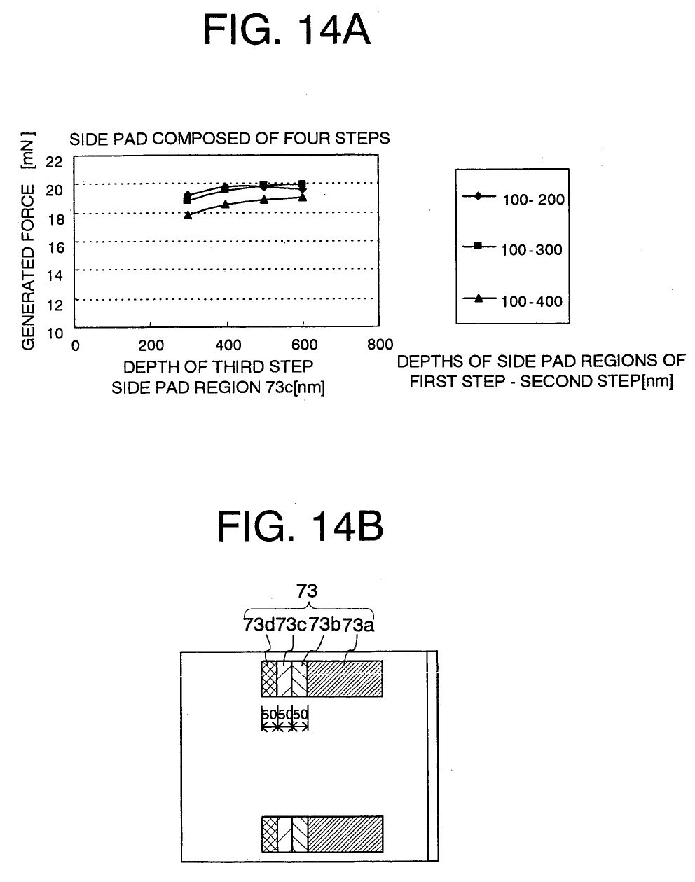

FIG. 14A and FIG. 14B are examples when the number of steps of the side pad 72 in FIG. 13A and FIG. 13B is increased one more step to be a four-step structure, and the range of the fourth step side pad region 73d is set as 100 um to 150 um from the inflow end of the side pad 73. In this case, the maximum generated force becomes 19.9 mN when the depth of the second step side pad region 73b from the non-milling surface is 100 nm, the depth of the third step side pad region 73c from the non-milling surface is 300 nm, and the depth of the fourth step side pad region 73d from the non-milling surface is 600 nm.

From an analysis of the above, it can be confirmed that the maximum generation pressure of three-steps side pad is increased dramatically compared to that of the two-steps side pad, and further large generated force can be obtained when steps are added so that the step becomes deeper as it comes nearer to the inflow side. Namely, it is desirable that the shallowest milling surface being milling processed is formed at the depth of 50 nm to 200 nm from the non-milling surface, and further, the next shallowest milling surface from the non-milling surface is formed deeper than the shallowest milling surface and at the depth of 100 nm to 700 nm from the non-milling surface.

As stated above, according to the magnetic head slider 5 of the present embodiment, in addition to the improvement of the pressure reducing characteristic, a robustness relative to an error in roll moment at the side pad is improved. Besides, according to the magnetic head slider 5 of the present embodiment, a desired pressure can be generated by the flying surface (ABS) of a small area. Further, for example, a magnetic disk drive with a slow peripheral speed, mounted on a power-saving type mobile PC, and so on, can generate a predetermined flying pressure to the slider.

As described above, according to the embodiment of the present invention, the cycle of the masking, the milling, the removal of the mask is performed for at least three cycles, and thereby, the milling surfaces with heights of at least four varieties or more exceeding the number of milling processes can be formed easily. Therefore, according to the embodiment of the present invention, it is possible to select desired heights of the milling surfaces from a plurality of varieties by a combination of the mask pattern and the depth of the milling, and therefore, the flexibility of the height setting of the flying surfaces to be formed on the slider is improved, and the flying characteristic of the slider including the pressure reducing characteristic, and so on, can be improved. Further, according to the embodiment of the present invention, the process forming of the height of the flying surfaces can be performed easily only by changing the combination of the masking and the milling accordingly, and therefore, the improvement of the pressure reducing characteristic can be realized at low cost.

Besides, the manufacturing method of the magnetic head slider according to the embodiment of the present invention includes the process that, when the milling surfaces processed from the surface of the slider and having different milling depths are disposed adjacently with each other, the region to be a deeper milling surface when completed is subject to milling by the milling processing performed when the region to be a shallower milling surface when completed is formed.

Further, the manufacturing method of the magnetic head slider according to the embodiment of the present invention includes that, when the milling surfaces processed from the surface of the slider and having different milling depths are disposed adjacently with each other, the masks are formed so that the opening portions of the masks respectively formed in the respective regions of the deep milling surface and the shallow milling surface, are overlapped with each other.

Besides, the manufacturing method of the magnetic head slider according to the embodiment of the present invention includes that, the sallowest milling surface milling processed from the surface of the slider is formed at the depth of 50 nm to 200 nm from the non-milling surface, and further, the next shallowest milling surface from the non-milling surface is formed deeper than the shallowest milling surface and at the depth of 100 nm to 700 nm from the non-milling surface.

Further, the manufacturing method of the magnetic head slider according to the embodiment of the present invention includes that, when the depth of the shallowest milling surface, which is formed by milling process from the surface of the slider, from the non-milling surface is set as one, and when N is a natural number, the milling depths in the respective milling processes are set within the range of 0.9×2^{N} to 1.1×2^{N}. Besides, the magnetic head slider according to the embodiment of the present invention includes the magnetic head slider manufactured by any one of the above-stated manufacturing methods. Further, the magnetic disk device according to the embodiment of the present invention includes the magnetic disk device including the magnetic head slider.

As described above, according to the present invention, it is possible to provide the manufacturing method of the magnetic head slider, the magnetic head slider and the magnetic disk device, in which the pressure reducing characteristic can be improved at low cost.

Hereinbefore, the present invention is described concretely by the embodiment. However, the present invention is not limited to the specific details and respective embodiments described here with the illustrations, but it is to be understood that all the changes and modifications without departing from the sprit or scope of the general inventive concept as defined by the following claims are to be included therein. For example, in the above-stated embodiment, the processes performed within the processes digging out the surface of the slider are not described especially, but the milling to dig out the slider surface can be a dry etching including an ion etching or an RIE (reactive ion etching), and so on, or a wet etching.

1. A manufacturing method of a magnetic head slider, comprising:
milling processes for at least three times performed on a slider to form a flying surface, providing variety of depths more than the number of said milling processes to be milling processed.

2. A manufacturing method of the magnetic head slider according to claim 1,
wherein said milling process for three times includes:
a first milling process forming a first mask on the slider to form the flying surface, performing a milling at a first depth from a surface never subjected to a milling;
a second milling process changing the first mask to a second mask and performing the milling at a second depth from the surface never subjected to a milling, after the first milling process; and
a third milling process changing the second mask to a third mask and performing the milling at a third depth from the surface never subjected to a milling, after the second milling process.

3. A manufacturing method of the magnetic head slider according to claim 2,
wherein when milling surfaces which are milling processed from a surface of the slider and having different milling depths are disposed adjacently with each other, a region to be a deeper milling surface of the milling surfaces is milled by the milling processing used for a shallower milling surface.

4. A manufacturing method of the magnetic head slider according to claim 2,
wherein when milling surfaces which are milling processed from a surface of the slider and having different milling depths are disposed adjacently with each other, the masks are formed to overlap opening portions of the masks respectively formed at respective regions of a deeper milling surface and a shallower milling surface, with each other.

5. A manufacturing method of the magnetic head slider according to claim 2,
wherein sallowest milling surface which is milling processed from a surface of the slider is formed at a depth of 50 nm to 200 nm from the surface never subjected to a milling, and further, next shallowest surface from the surface never subjected to a milling is formed deeper than the shallowest milling surface and at a depth of 100 nm to 700 nm from the surface never subjected to a milling.

6. A manufacturing method of the magnetic head slider according to claim 2,
wherein when a depth of shallowest milling surface which is milling processed from a surface of the slider, from the surface never subjected to a milling is set as one, and when N is a natural number, then milling depths in the respective milling processes are set within a range of 0.9×2^{N} to 1.1×2^{N}.

7. A magnetic head slider manufactured by the manufacturing method according to claim 2.

8. A magnetic disk device including the magnetic head slider according to claim 7.

9. A magnetic head slider manufactured by the manufacturing method according to claim 3.

10. A magnetic disk device including the magnetic head slider according to claim 9.

11. A magnetic head slider manufactured by the manufacturing method according to claim 4.

12. A magnetic disk device including the magnetic head slider according to claim 11.

13. A magnetic head slider manufactured by the manufacturing method according to claim 5.

14. A magnetic disk device including the magnetic head slider according to claim 13.

15. A magnetic head slider manufactured by the manufacturing method according to claim 6.

16. A magnetic disk device including the magnetic head slider according to claim 15.
